(19) United States
(12) Patent Application Publication
(10) Pub. No.: US 2009/0047383 A1
(43) Pub. Date: Feb. 19, 2009

(54) Manufacturing Method of Black Vinegar and Black Vinegar Manufactured by the Method

(76) Inventors: Yasushi Ogasawara, Hekinan-shi (JP); Yoshiaki Otsuji, Handa-shi (JP); Hirofumi Akano, Handa-shi (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/085,019

(22) PCT Filed: Jun. 27, 2006
(86) PCT No.: PCT/JP2006/312775

§ 371 Date: May 14, 2008

(30) Foreign Application Priority Data
Dec. 22, 2005 (JP) 2005-369147

(51) Int. Cl. C12J 1/04

(52) U.S. Cl. 426/17; 426/650

(57) ABSTRACT

An object of the present invention is to provide a manufacturing method of black vinegar which contains sugar derived from rice and barley abundantly, and is free from precipitation, and black vinegar manufactured by the method.

The present invention provide a manufacturing method of black vinegar having the sugar content of 8-50 weight/volume % derived from rice and/or barley, wherein acetic acid fermentation is performed by mixing a saccharified solution and an alcoholic fermented broth of rice and/or barley, and the final concentration of oxalic acid in black vinegar is 36 ppm or less, and preferably 30 ppm or less.

In addition, as a decreasing method of oxalic acid in black vinegar, storing with stirring a saccharified solution of rice and/or barley or a fermented broth after completion of acetic acid fermentation is effective. And the present invention provides black vinegar manufactured by these methods in which oxalate precipitation is hardly to occur, and which is suitable for drinking.

### TECHNICAL FIELD

The present invention relates to a manufacturing method of black vinegar containing sugar derived from rice or barley as raw material at a high concentration and the black vinegar manufactured by the method, and in particular, it relates to a manufacturing method of black vinegar having good quality to be suitable for drinking which relieves the taste peculiar to black vinegar because of containing sugar at a high concentration and is free from precipitation resulted from oxalic acid derived from the raw material, and the black vinegar manufactured by the method.

### BACKGROUND ART

In recent years, intake of vinegar as a drink has become popular. Among vinegar, black vinegar manufactured from rice or barley as raw material is especially in high demand, since it includes nutrients such as amino acids and minerals abundantly, and since it is known to have various health care functions.

However, when one drinks conventional black vinegar by diluting with water, he/she occasionally experiences uneasiness to drink because it has taste and flavor peculiar to black vinegar.

In order to resolve the uneasiness to drink black vinegar, methods to add sugar such as honey to black vinegar before drinking, moreover, a method to manufacture vinegar using raw material such as unpolished rice and having a higher sugar concentration than the conventional black vinegar, which comprises having the acidity of 2% or more, the sugar content of 10-30%, and the extract content of 16-40%, by adjusting the sugar content of alcohol-containing mash within 10 to 30% in advance, then performing acetic acid fermentation (for example, refer to patent document No. 1) is disclosed.

Among these methods to increase the sugar concentration, in the former methods to add sugar such as honey to black vinegar, it is troublesome to adjust sugar concentration appropriately, and the resultant black vinegar tends to lose taste balance as the sweetness is felt separately. Therefore, the method like the latter to increase the sugar concentration before acetic acid fermentation is considered to be preferable.

In order to increase the sugar content in the latter methods, grain such as rice and barley have to be used as raw material in a larger amount than usual, since the use of sugar-containing raw material other than rice and barley is restricted by the quality standards of black vinegar.

However, when black vinegar is manufactured by using grain such as rice and barley as raw material in a larger amount than usual, it was confirmed as a problem that precipitation is liable to occur in black vinegar. As to such a problem of occurrence of precipitation, even the presence of the problem is not described in the above mentioned patent document No. 1. Accordingly, when black vinegar with the increased sugar content is manufactured by using of grain such as rice and barley as raw material in a larger amount than usual, there has been a need to develop a method to prevent the precipitation.

Patent document No. 1: Japanese Patent Laid-open No. S61-96981

### DISCLOSURE OF THE INVENTION

### Problems to be Solved by the Invention

An object of the present invention is to provide a manufacturing method of black vinegar which contains sugar derived from rice or barley abundantly but never causes precipitation, and the black vinegar manufactured by the method.

### Means for Solving the Problems

As a result of an extensive research in order to solve the problems, the inventors found that a factor to occur precipitation in black vinegar containing large amount of sugar derived from raw material of rice or barley used abundantly was oxalic acid derived from the raw material, specified the concentration of oxalic acid in black vinegar which can prevent the occurrence of crystallization and precipitation of oxalate (calcium oxalate), further developed a method to decrease the concentration of oxalic acid derived from the raw material to the concentration or lower, and completed the present invention.

That is, the present invention relates to following (1) to (5).

(1) A manufacturing method of black vinegar containing 8-50 weight/volume % of sugar derived from rice and/or barley, wherein a saccharified solution and an alcoholic fermented broth of rice and/or barley are mixed to perform acetic acid fermentation, and the final concentration of oxalic acid in black vinegar is decreased to 36 ppm or less.
(2) The manufacturing method of black vinegar according to above (1), wherein the final concentration of oxalic acid in black vinegar is decreased to 30 ppm or less.
(3) The manufacturing method of black vinegar according to above (1), wherein the saccharified solution prepared in such a manner that the concentration of oxalic acid is equal to or less than the value given by the following formula 1 is used as the saccharified solution.

The oxalic acid concentration in the saccharified solution (ppm)=33.6÷the using ratio of the saccharified solution (parts by volume/100) (Formula 1)

(4) The manufacturing method of black vinegar according to above (2), wherein the saccharified solution prepared in such a manner that the concentration of oxalic acid is equal to or less than the value given by the following formula 2 is used as the saccharified solution.

The oxalic acid concentration in the saccharified solution (ppm)=27.8÷the using ratio of the saccharified solution (parts by volume/100) (Formula 2)

(5) The manufacturing method of black vinegar according to any of above (1) to (4), wherein oxalic acid removal treatment is performed by storing the saccharified solution with stirring.
(6) The manufacturing method of black vinegar according to any of above (1) to (5), wherein oxalic acid removal treatment is performed by storing the fermented broth after completion of acetic acid fermentation with stirring.
(7) Black vinegar produced by manufacturing methods according to above (1) to (6).

### EFFECTS OF THE INVENTION

According to the present invention, although the black vinegar abundantly contains sugar derived from raw material such as unpolished rice or barley, the content of oxalic acid is small. As a result, black vinegar which is free from crystallization and precipitation of oxalate and is suitable for drinking only by dilution with water is provided.

### BRIEF DESCRIPTION OF THE DRAWINGS

FIG. 1: The graph shows the relation, in test example 1, among the oxalic acid concentration in black vinegar (ppm) (a), the oxalic acid concentration in the saccharified solution (ppm) (b), and the using ratio of the saccharified solution (parts by volume/100) (c).

### BEST MODE FOR CARRYING OUT THE INVENTION

The present invention is described in detail as below.

The present invention relating to Claim 1 is a manufacturing method of black vinegar containing 8-50 weight/volume % of sugar derived from rice and/or barley, in which a saccharified solution and an alcoholic fermented broth of rice and/or barley are mixed to perform acetic acid fermentation, and the final concentration of oxalic acid in black vinegar is decreased to 36 ppm or less.

The black vinegar in the present invention is defined by the Vinegar Quality Standards (refer to the Notification No. 1821 of Japanese Ministry of Agriculture, Forestry, and Fisheries, amended on Oct. 7, 2004), and it is consisting of rice black vinegar and barley black vinegar.

In which, the rice black vinegar is defined as “a kind of grain vinegar, which is produced by using only rice (except rice that is polished after removing the whole bran layer of unpolished rice, which is applicable in the same item hereinafter.) or the rice added with wheat or barley as raw material, and which uses the rice in an amount of 180 g or more per 1 L of the grain vinegar, and is colored brown or blackish brown through fermentation and aging”.

The barley black vinegar is also defined as “a kind of grain vinegar, which is produced by using only barley as raw material in an amount of 180 g or more per 1 L of the grain vinegar, and is colored brown or blackish brown through fermentation and aging”.

The rice used in the present invention as raw material is other than rice that the whole bran layer of unpolished rice is removed and polished, specifically, implies unpolished rice or polished rice with incompletely-removed bran part from unpolished rice. The polished rice with incompletely-removed bran part from unpolished rice is substantially applicable to rice having approximately less than 6% of removal ratio of bran layer from surface of unpolished rice (hereafter, referred to as polishing ratio), that is, rice with approximately less than 6% of polishing ratio. In the present invention, in particular, rice with 0-5% of polishing ratio is preferably used. In addition, the rice described above after crushing or grinding is preferably used.

In the method of the present invention, the amount of above-mentioned rice used for preparation of a saccharified solution is 20-45 weight/volume %, preferably 30-40 weight/volume % to the saccharified solution (before filtration). If the using amount of the rice exceeds the upper limit, the viscosity becomes higher and saccharification reaction does not proceed uniformly, therefore, it is not preferable. On the other hand, if the using amount of the rice is less than the lower limit, the targeted black vinegar containing a high concentration of sugar can not be obtained, therefore, it is not preferable either.

However, as raw material, barley described below and rice can be used together. In such a case, the using amount of barley must be adjusted so that the using amount of rice becomes 180 g or more per 1 L of the grain vinegar.

Moreover, the barley used in the present invention as raw material, similarly as in the case of the rice described above, implies unpolished barley or polished barley with incompletely-removed bran part from unpolished barley. The polished barley with incompletely-removed bran part from unpolished barley is substantially applicable to barley with approximately less than 30% of polishing ratio. In the present invention, in particular, barley with 0-15% of polishing ratio is preferably used. In addition, the barley described above is preferably used after crushing or grinding.

In case of manufacturing barley black vinegar, the amount of above-mentioned barley used for preparation of a saccharified solution is 20-45 weight/volume %, preferably 30-40 weight/volume % to the saccharified solution (before filtration). If the using amount of the barley exceeds the upper limit, the viscosity becomes higher and saccharification reaction does not proceed uniformly, therefore, it is not preferable. On the other hand, if the using amount of the barley is less than the lower limit, the targeted black vinegar containing a high concentration of sugar can not be obtained, therefore, it is not preferable either.

Generally, preparation of black vinegar is performed by the method below.

That is, first, using the rice and/or the barley described above as raw material, starch in the raw material is saccharified with koji or saccharifying enzymes, then lees of saccharified rice and/or barley and the like are removed by filtration etc., and a saccharified solution is prepared. Then the saccharified solution is subjected to alcoholic fermentation with yeast, solids such as sake lees are removed by filtration etc., and an alcoholic fermented broth is obtained. Furthermore, the obtained alcoholic fermented broth as an alcohol-containing solution is mixed with seed vinegar and is subjected to acetic acid fermentation with acetic acid bacteria. After completion of acetic acid fermentation, the reaction mixture is subjected to aging as appropriate, filtered, sterilized, filled into containers such as bottles, and black vinegar is manufactured.

Another manufacturing method in which, in a container such as a jar, above saccharification, alcoholic fermentation, and acetic acid fermentation processes are concurrently performed is also known.

When black vinegar is manufactured by such a general method, almost all of sugar derived from rice and/or barley as raw material is transformed into alcohol and consumed in the alcoholic fermentation process, and the sugar concentration of the obtained black vinegar is generally low, that is, black vinegar having the sugar concentration of 8 weight/volume % or more, for example, is not manufactured in general.

The method of the present invention is to manufacture black vinegar having a high sugar concentration and can be drunk deliciously only by diluting with water. Therefore, the black vinegar must contain a higher concentration of sugar derived from raw material such as rice and barley than that of conventional black vinegar.

Accordingly, in the method of the present invention, when preparing alcohol-containing solution before acetic acid fermentation, instead of using an alcoholic fermented broth obtained through alcoholic fermentation of a saccharified solution from rice and/or barley, saccharified solution before alcoholic fermentation is added to alcoholic fermented broth so as to increase the sugar concentration in the obtained alcohol-containing solution, and acetic acid fermentation is performed, whereby manufacturing the black vinegar having concentration of sugar derived from rice and/or barley as high as 8 to 50 weight/volume %.

As described above, an alcohol-containing solution in the present invention is prepared by mixing a saccharified solution from rice and/or barley and an alcoholic fermented broth obtained through alcoholic fermentation of the saccharified solution (or through concurrent saccharification and alcoholic fermentation of the above mentioned raw material) together with water optionally added. The using ratio of each raw material in preparing alcohol-containing solution and the mixing ratio of the alcohol-containing solution with the seed vinegar can be adjusted as appropriate depending on such as the sugar concentration and the acidity of the final black vinegar to be obtained.

A saccharified solution in the present invention can be prepared in a similar manner as that of the saccharified solution used in general manufacturing method of black vinegar described above. That is, by suspending rice and/or barley as raw material described above in water at the ratio described above, and saccharifying by adding koji or saccharifying enzymes, the saccharified solution can be obtained.

The sugar concentration of the saccharified solution thus prepared is 10-25 weight/volume %. When a saccharified solution with a higher sugar concentration than the above mentioned concentration is needed, a saccharified solution with an increased sugar concentration may be prepared through concentration (hereafter, referred to as a concentrated saccharified solution in some cases) by the known methods such as concentration under reduced pressure and used. The term “saccharified solution” in the present invention also refers to such concentrated saccharified solution.

The sugar concentration of black vinegar manufactured by the method of the present invention is thus increased, and the particular concentration of sugar derived from rice and/or barley is 8-50 weight/volume %, preferably approximately 15-35 weight/volume %.

Since sugar in the alcoholic fermented broth has been consumed in alcoholic fermentation and hardly remains, most of sugar in the final black vinegar is derived from the saccharified solutions. Accordingly, the sugar concentration in black vinegar can be adjusted by changing the sugar concentration of the saccharified solution and its using ratio in preparation of the alcohol-containing solution described above.

If the sugar concentration in black vinegar is less than 8 weight/volume %, the sugar concentration is as low as that of conventional black vinegar and the effect to relieve taste peculiar to black vinegar is small. Thus the black vinegar is not preferable, as it is not suitable for drinking deliciously only by diluting with water.

On the other hand, if the sugar concentration in black vinegar is more than 50 weight/volume %, growth of acetic acid bacteria becomes difficult, and acetic acid fermentation can not be performed well, thus it is also not preferable for black vinegar manufacturing.

The concentration of the organic acids such as acetic acid in black vinegar manufactured by the method of the present invention is not especially limited. However, the acidity is preferably approximately 2-6% from the view point that it is drinkable deliciously only by diluting with water. The acidity (%) can be obtained by performing neutralization titration of the organic acids such as acetic acid with a sodium hydroxide solution and converting into the acetic acid concentration.

The sugar content in the present invention is the sum of sweet-tasting sugar, and specifically, can be obtained by summing the concentration (in weight/volume %) of glucose, maltose, fructose, sucrose, sorbitol, and glycerol. The measurement of the sugar can be performed, for example, by using liquid chromatography (HPLC) for sugar analysis under following HPLC conditions.

<HPLC Conditions>

Column: Shodex Asahipak NH2P-50 4E (4.6 mmID×250 mm) (manufactured by Showa Denko K.K.)

Eluate: CH₃CN/H₂O=75/25

Detector: RI detector

Flow rate: 1.0 mL/min

Column temperature: 30° C.

The present invention is to solve the problem that when sugar derived from rice and/or barley as raw material used for black vinegar is allowed to be contained abundantly, the used amount of raw material increases, and as a result, the oxalic acid concentration becomes higher and precipitation occurs.

Since oxalic acid in rice and barley is mainly included in rice bran part and barley bran part, the problem does not occur in vinegar manufactured by using polished rice and polished barley even by increasing sugar content, and the problem can be said particularly significant in black vinegar manufacturing.

In the method of the present invention, in order to manufacture black vinegar containing 8-50 weight/volume % of sugar derived from rice and/or barley, as described above, a saccharified solution from rice and/or barley and an alcoholic fermented broth together with water optionally added are mixed to prepare an alcohol-containing solution having a high sugar concentration, and then acetic acid fermentation is performed.

The oxalic acid concentration in black vinegar thus manufactured is more than 36 ppm and it was firstly demonstrated by the present invention that, in such a case, precipitation of oxalate (calcium oxalate) occurred. However, it was also found that, if the oxalic acid concentration in final black vinegar was decreased to 36 ppm or less, preferably 30 ppm or less, precipitation of oxalate did not occur in black vinegar with the sugar content of 8 weight/volume % or more.

The measurement of the oxalic acid concentration can be performed, for example, by using liquid chromatography (HPLC) for organic acid analysis under following HPLC conditions.

<HPLC Conditions>

Column: Shodex KC811 (8 mmID×300 mm) (manufactured by Showa Denko K.K.)

Eluate: 0.1% phosphate solution

Detector: UV detector 210 nm

Flow rate: 1.0 mL/min

Column temperature: 50° C.

In the method of the present invention, it is preferable to perform the oxalic acid removal treatment, in order to decrease the oxalic acid concentration in the final black vinegar to the value described above or less. The methods of oxalic acid removal treatment are not especially limited, but as specific examples, a method to filter out oxalate precipitate occurred during storage in static state, a method to filter out oxalate precipitate occurred during storage with stirring, a method to absorb and remove oxalic acid by treating with anion-exchange resins, a method to treat oxalic acid with decomposition enzymes, a method to add calcium to filter out the occurred oxalate precipitate, and a method to absorb and remove oxalic acid by passing through a column filled with calcium can be mentioned.

Among them, the method to filter out oxalate precipitate occurred during storage in static state is excellent in that it can be done easily, however, it takes a long time to reduce oxalic acid to a desired concentration and it is often difficult to predict the required storage period. Therefore, as described in Claims 5 and 6, the method to store in stirring state is more preferable.

The method to store in stirring state can promote crystallization of oxalate (calcium oxalate) through stirring, and can generate oxalate precipitate in a short period. The stirring condition in the method is not particularly limited, however, for example, the preferable ratio of diameter of the impeller to inside diameter of the storage container is approximately 0.2 to 0.9. In addition, the preferable ratio of the mounting height of the impeller to the liquid level is approximately 0.05 to 0.45 and the preferable stirring speed is approximately 10 rpm to 600 rpm. Stirring may be continuous or intermittent. When intermittently stirred, the total stirring time is preferably 1/10 or more of the total non-stirring time.

As a result of such treatment, once the oxalic acid concentration becomes equal to or less than the desired concentration described above, then stirring may be stopped and the solution may be left in static state, or stirring may be continued further. The storage temperature during stirring is preferably approximately 0-30° C., more preferably 0-20° C.

Black vinegar is manufactured by adding acetic acid bacteria to alcohol-containing solution and performing acetic acid fermentation. In the present invention, in order to increase the sugar content in the black vinegar, it is necessary to increase the sugar content in the alcohol-containing solution.

Therefore, in the method of the present invention, as described above, an alcohol-containing solution having a high sugar concentration is prepared by mixing an alcoholic fermented broth obtained through alcoholic fermentation of a saccharified solution from rice and/or barley (or through concurrent saccharification and alcoholic fermentation of raw material described above) and a saccharified solution before alcoholic fermentation together with water optionally added.

In the method of the present invention, there is no limitation in the timing of performing the oxalic acid removal treatment, and the treatment may be performed at any stage such as a saccharified solution, an alcohol-containing solution before acetic acid fermentation, and an acetic acid fermented broth after acetic acid fermentation as described in Claim 5.

However, as it was found that the oxalic acid concentration in the saccharified solution from rice and/or barley was high, and the derived oxalic acid accounted for the majority of the oxalic acid content in the final black vinegar, it is preferable to reduce the oxalic acid concentration in a saccharified solution from rice and/or barley in advance, as described in Claim 6.

The reason is that the treatment time for removal of oxalic acid is shorter and the amount of the liquid to be treated is smaller when treatment for oxalic acid removal is performed in a saccharified solution from rice and/or barley containing oxalic acid at a higher concentration.

When the oxalic acid removal treatment is performed for the saccharified solution, the goal value of the oxalic acid concentration in the saccharified solution can be obtained through calculation taking into account the using ratio of the saccharified solution in the preparation of the alcohol-containing solution, so that the oxalic acid concentration in the final black vinegar is 36 ppm or less, more preferably, as described in Claim 2, 30 ppm or less.

In this case, it was confirmed that an alcoholic fermented broth and a seed vinegar used in the manufacturing of black vinegar of the present invention contain almost no oxalic acid, and almost all of oxalic acid in the black vinegar obtained by the method of the present invention is derived from the saccharified solution. That is, the oxalic acid concentration in an alcoholic fermented broth decreases and reaches very low level during alcoholic fermentation. For example, the oxalic acid concentration after the alcoholic fermentation of the saccharified solution whose oxalic acid concentration is approximately 90 ppm decreases to approximately 8 ppm. Also, the oxalic acid concentration in seed vinegar manufactured by diluting an alcoholic fermented broth and performing acetic acid fermentation is, for example, approximately 5 ppm.

Since black vinegar having a high sugar concentration obtained by the method of the present invention is manufactured by acetic acid fermentation by blending an alcoholic fermented broth and a seed vinegar both having a low oxalic acid with a saccharified solution, almost all of oxalic acid in the final black vinegar is derived from the saccharified solution.

Therefore, when manufacturing black vinegar having the oxalic acid concentration of, for example, 36 ppm or less, as described in Claim 3, the oxalic acid concentration in a saccharified solution should be equal to or less than the value calculated through following formula 1.

The oxalic acid concentration in the saccharified solution (ppm)=33.6÷the using ratio of the saccharified solution (parts by volume/100), (Formula 1)

wherein the using ratio of the saccharified solution is the ratio to the total of the alcohol-containing solution and the seed vinegar.

In a similar manner, when manufacturing black vinegar having an oxalic acid concentration of 30 ppm or less, as described in Claim 4, the oxalic acid concentration in a saccharified solution should be equal to or less than the value calculated through following formula 2.

The oxalic acid concentration in the saccharified solution (ppm)=27.8÷the using ratio of the saccharified solution (parts by volume/100), (Formula 2)

wherein the using ratio of the saccharified solution is the ratio to the total of the alcohol-containing solution and the seed vinegar.

Incidentally, as described above, a saccharified solution having decreased oxalic acid concentration is not only used on the occasion to prepare the alcohol-containing solution, but it is indeed possible to be used to obtain an alcoholic fermented broth through alcoholic fermentation of the saccharified solution, as well.

Although the black vinegar of the present invention relating to Claim 7 thus manufactured has the sugar content of 8-50 weight/volume %, by using large amount of rice and/or barley as raw material, the oxalic acid concentration is kept low at 36 ppm or less, preferably 30 ppm or less. As a result, precipitate due to oxalate can be prevented from occurring, and in addition, the high sugar concentration relieves the taste peculiar to black vinegar, resulting in the black vinegar suitable for drinking.

### EXAMPLE

The present invention is explained specifically by showing test examples and examples, however the present invention is not limited to those.

### Test Example 1

### Determination of the Oxalic Acid Concentration in Black Vinegar in which Precipitation does not Occur

### 1. Preparation of a Rice-Saccharified Solution and a Concentrated Rice-Saccharified Solution

Six Kg of rice that was ground (polishing ratio: 5%) was suspended in water so as to make a total volume of 20 L. The suspension was added with 20 g of an α-amylase preparation (Kleistase T-5: manufactured by Daiwa Kasei K.K.), and liquefied while maintaining at 90° C. for 90 minutes with stirring. After liquefaction, the α-amylase was inactivated by heating at 120° C. for 20 minutes. The liquid was cooled to 58° C., and was added with 40 g of a glucoamylase preparation (Sumizyme: manufactured by Shin Nihon Chemical Co., Ltd.) and log of a protease preparation (Sumizyme LP-50: manufactured by Shin Nihon Chemical Co., Ltd.). Saccharification was continued at 58° C. for 18 hours, and then by filtration with filter press, a rice-saccharified solution was obtained. The sugar concentration of the rice-saccharified solution was 20 weight/volume % and the oxalic acid concentration of the rice-saccharified solution was 92 ppm.

Furthermore, the rice-saccharified solution was concentrated under reduced pressure and a concentrated rice-saccharified solution having the sugar content of 60 weight/volume % was prepared. The oxalic acid concentration of the concentrated rice-saccharified solution was 150 ppm.

Note that the measurement of the sugar concentration was performed by the method described below.

### 2. Preparation of a Rice Alcoholic Fermented Broth

Six Kg of rice that was crushed (polishing ratio: 5%), 1 Kg of rice koji that was ground (rice with polishing ratio of 5% which was steamed under normal pressure, cooled, inoculated with seed koji fungus Aspergillus oryzae, cultured at 30° C. for 3 days, and dried, according to the known method), 20 g of an α-amylase preparation (Kleistase T-5: manufactured by Daiwa Kasei K.K.), 20 g of a glucoamylase preparation (Sumizyme: manufactured by Shin Nihon Chemical Co., Ltd.), and 40 g of a protease preparation (Sumizyme LP-50: manufactured by Shin Nihon Chemical Co., Ltd.) were suspended in water so as to make a total volume of 20 L. The suspension was added with 25 g of yeast (Saccharomyces cerevisiae (manufactured by Oriental Yeast Co., Ltd.)), and subjected to alcoholic fermentation at 30° C. for 5 days, filtrated, and a rice alcoholic fermented broth was obtained. The alcohol concentration of the rice alcoholic fermented broth was 15 volume/volume % and the oxalic acid concentration was 8 ppm.

### 3. Preparation of Rice Black Vinegar

As shown in table 1, 70 parts by volume of the alcohol-containing solution (the alcohol concentration: 2.5%) prepared by mixing the rice-saccharified solution or the concentrated rice-saccharified solution, and the rice alcoholic fermented broth described above with water as appropriate, was mixed with 30 parts by volume of the seed culture, that is, the seed vinegar (a fermenting broth containing acetic acid bacteria having vigorous activity in Acetobacter aceti continuous acetic acid fermentation by using the rice alcoholic fermented broth described above in a submerged fermenter under conditions: at 30° C., 500 rpm, 0.2 vvm, acidity: 7.5 weight/volume % and the alcohol concentration: 0.4 volume/volume %). Then acetic acid fermentation was performed by submerged fermentation method (at 30° C., 500 rpm, 0.2 vvm) until its alcohol concentration became approximately 0.3 volume/volume %, and a fermented broth after completion of acetic acid fermentation was obtained. Incidentally, the oxalic acid concentration of the seed vinegar was 5 ppm. Then the fermented broth was subjected to aging for approximately 3 months, filtrated after completion of aging, filled into bottles, thermally sterilized, sealed, and black vinegar was obtained.

As to the obtained black vinegar, the sugar content and the oxalic acid concentration were measured, and whether precipitation of oxalate occurred or not was investigated by storing it in a refrigerator (5° C.) for a month.

Note that the sugar concentration was calculated by summing each concentration (in weight/volume %) of glucose, maltose, fructose, sucrose, sorbitol, and glycerol measured by using liquid chromatography (HPLC for sugar analysis) under following HPLC conditions.

<HPLC Conditions>

Column: Shodex Asahipak NH2P-50 4E (4.6 mmID×250 mm) (manufactured by

Showa Denko K.K.)

Eluate: CH₃CN/H₂O=75/25

Detector: RI detector

Flow rate: 1.0 mL/min

Column temperature: 30° C.

In addition, the oxalic acid concentration was obtained by using liquid chromatography (HPLC) for organic acid analysis and analyzing under following HPLC conditions.

<HPLC Conditions>

Column: Shodex KC811 (8 mmID×300 mm) (manufactured by Showa Denko K.K.)

Eluate: 0.1% phosphate solution

Detector: UV detector 210 nm

Flow rate: 1.0 mL/min

Column temperature: 50° C.

The results are shown in table 2. In the table, the occurrence of oxalate precipitation is shown with, −: none, ±: little, +: noticeable and not preferable, and ++: remarkable and not preferable.

TABLE 1

| Test area | 1 | 2 | 3 | 4 | 5 | 6 |
|---|---|---|---|---|---|---|
| Rice-saccharified | 20 | 30 | 35 | 40 | 0 | 0 |
| solution | | | | | | |
| Concentrated | 0 | 0 | 0 | 0 | 30 | 42 |
| rice-saccharified | | | | | | |
| solution | | | | | | |
| Rice alcoholic | 14 | 14 | 14 | 14 | 14 | 14 |
| fermented broth | | | | | | |
| Water | 36 | 26 | 21 | 16 | 26 | 14 |

Unit: part by volume

TABLE 2

| Test area | 1 | 2 | 3 | 4 | 5 | 6 |
|---|---|---|---|---|---|---|
| Sugar concentration | 4 | 6 | 7 | 8 | 18 | 25 |
| (weight/volume %) | | | | | | |
| Oxalic acid concentration | 19 | 30 | 36 | 38 | 50 | 65 |
| (ppm) | | | | | | |
| Oxalate precipitation | − | − | ± | + | ++ | ++ |

According to above results, it was found that if the oxalic acid concentration in black vinegar was 38 ppm or more, there was the adverse effect to cause oxalate precipitation during storage of bottled black vinegar. While if the oxalic acid concentration was 36 ppm or less, oxalate precipitation occurred slightly but not noticeably. Furthermore, when the oxalic acid concentration was 30 ppm or less, no precipitation of oxalate was observed.

Additionally, following analysis was performed as to test results described above.

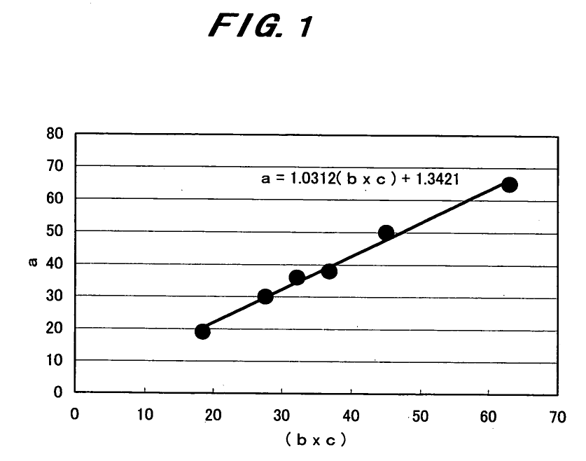

That is, when the results of test area 1-6 shown in table 2 was graphed in the relation between a and (b×c), wherein, a is the oxalic acid concentration in black vinegar (ppm), b is the oxalic acid concentration in a saccharified solution (ppm), and c is the using ratio of the saccharified solution to the total of the alcohol-containing solution and the seed vinegar (parts by volume/100), it was found that there was a relation as shown in FIG. 1.

Depending on the results of FIG. 1, an approximation formula as to the relation between a and (b×c) was determined through least-squares method, and the following formula 3 was obtained.

a=1.0312(b×c)+1.3421 (Formula 3)

Based on the result, it was confirmed that almost all of oxalic acid in black vinegar was derived from the saccharified solution, and the oxalic acid concentration in black vinegar and the using ratio of the saccharified solution were in almost proportional relation, that is, the oxalic acid concentration in black vinegar could be determined by the oxalic acid concentration in the saccharified solution and its using ratio.

### Test Example 2

### Methods of Oxalic Acid Removal Treatment

In a similar manner as test example 1, 70 parts by volume of the alcohol-containing solution (the alcohol concentration: 2.5%), which was prepared by mixing 30 parts by volume of concentrated rice-saccharified solution prepared in text example 1, 14 parts by volume of rice alcoholic fermented broth and 16 parts by volume of water, was mixed with 30 parts by volume of seed vinegar (prepared in a similar manner as test example 1), and acetic acid fermentation was performed by submerged fermentation method (at 30° C., 500 rpm, 0.2 vvm) until its alcohol concentration became approximately 0.3 volume/volume %, and a fermented broth after completion of acetic acid fermentation was obtained.

The obtained fermented broth was stored for a period shown in table 3, and changes of the oxalic acid concentration in the fermented broth were examined.

The oxalic acid concentration in the fermented broth (ppm) was measured for the case of storage in static state at 15° C. (static storage), and for the case of storage with stirring at 15° C. (the fermented broth was filled into a cylindrical container with a diameter of 25 cm and continuously stirred with an impeller having diameter of 6 cm at 90 rpm) (stirring storage), and their effects on the decrease of the oxalic acid concentration were compared. Note that the oxalic acid concentration was measured in a similar manner as in test example 1. Results were summarized in table 3.

TABLE 3

| | | Storage period (day) | | | | | | | |
|---|---|---|---|---|---|---|---|---|---|
| | | 0 | 2 | 5 | 14 | 30 | 45 | 80 | 100 |
| Oxalic acid (ppm) | Static | 50 | 50 | 46 | 40 | 42 | 38 | 40 | 39 |
| | storage | | | | | | | | |
| | Stirring | 50 | 50 | 46 | 35 | 30 | 25 | 24 | 25 |
| | storage | | | | | | | | |

Above results showed that the oxalic acid concentration in the fermented broth was decreased in both cases of static storage and stirring storage, however in the case of the static storage, decrease of the oxalic acid concentration was relatively slow, and even after storage for 100 days, the oxalic acid concentration was not decreased to 36 ppm at which oxalate precipitation can be prevented or less.

On the other hand, in the case of stirring storage, even after storage for relatively short time of 14 days, the oxalic acid concentration was decreased to 35 ppm, and after storage for 30 days, it was decreased to 30 ppm, that is, the oxalic acid concentration reached the level enough to prevent precipitation of oxalate. Therefore, it was confirmed that with stirring storage, the oxalic acid concentration could be decreased efficiently and effectively.

### Test Example 3

### Timing of Oxalic Acid to be Removed

### 1. Preparation of a Concentrated Rice-Saccharified Solution

Seven Kg of rice that was ground (polishing ratio: 5%) was suspended in water so as to make a total volume of 20 L. The suspension was added with 20 g of an α-amylase preparation (Kleistase T-5: manufactured by Daiwa Kasei K.K.), and liquefied while maintaining at 90° C. for 90 minutes with stirring. The α-amylase was inactivated by heating the liquid at 120° C. for 20 minutes under pressure, and then the liquid was cooled to 58° C., and added with 40 g of a glucoamylase preparation (Sumizyme: manufactured by Shin Nihon Chemical Co., Ltd.) and 10 g of a protease preparation (Sumizyme LP-50: manufactured by Shin Nihon Chemical Co., Ltd.). Saccharification was continued at 58° C. for 18 hours, and then by filtration with filter press, a rice-saccharified solution was obtained.

The sugar concentration of the rice-saccharified solution was 24 weight/volume %. Then, the rice-saccharified solution was concentrated under reduced pressure and a concentrated rice-saccharified solution having a sugar concentration of 49 weight/volume % was prepared. The oxalic acid concentration of the concentrated rice-saccharified solution was 140 ppm. In addition, the obtained concentrated rice-saccharified solution was stored with stirring for 4 days in a similar manner as test example 2, and the concentrated rice-saccharified solution having an oxalic acid concentration decreased to 75 ppm was prepared.

Note that the measurements of the sugar concentration and oxalic acid concentration were done in a similar manner as test example 1.

### 2. Preparation of a Rice Alcoholic Fermented Broth

Six Kg of rice that was ground (polishing ratio: 5%), 1 Kg of rice koji that was ground (prepared in a similar manner as test example 1), 20 g of an α-amylase preparation (Kleistase T-5: manufactured by Daiwa Kasei K.K.), 20 g of a glucoamylase preparation (Sumizyme: manufactured by Shin Nihon Chemical Co., Ltd.), and 40 g of a protease preparation (Sumizyme LP-50: manufactured by Shin Nihon Chemical Co., Ltd.) were suspended in water so as to make a total volume of 20 L. The suspension was added with 25 g of yeast (Saccharomyces cerevisiae (manufactured by Oriental Yeast Co., Ltd.)), subjected to alcoholic fermentation at 30° C. for 5 days, filtrated, and a rice alcoholic fermented broth was obtained. The alcohol concentration of the rice alcoholic fermented broth was 14.9 volume/volume %, and the oxalic acid concentration was 8 ppm.

### 3. Preparation of Rice Black Vinegar

Seventy parts by volume of the alcohol-containing solution (alcohol concentration: 2.5%) prepared by mixing 36 parts by volume of the concentrated rice-saccharified solution with decreased oxalic acid concentration described above, 14 parts by volume of the rice alcoholic fermented broth and 20 parts by volume of water was mixed with 30 parts by volume of the seed culture (prepared in a similar manner as test example 1). The mixture was subjected to acetic acid fermentation by submerged fermentation method (at 30° C., 500 rpm, 0.2 vvm) until its alcohol concentration became approximately 0.3 volume/volume %, and a fermented broth after completion of acetic acid fermentation (acetic acid fermented broth A) was obtained. The acetic acid fermented broth A had the acidity of 4.5%, the alcohol concentration of 0.3 volume/volume %, the sugar concentration of 16 weight/volume %, and the oxalic acid concentration of 24 ppm.

On the other hand, a fermented broth after completion of acetic acid fermentation (acetic acid fermented broth B) was obtained in a similar manner as described above except that the concentrated rice-saccharified solution was used in stead of the concentrated rice-saccharified solution with decreased oxalic acid concentration described above. Incidentally, the acetic acid fermented broth B had the acidity of 4.5%, the alcohol concentration of 0.35 volume/volume %, the sugar concentration of 16 weight/volume %, and the oxalic acid concentration of 50 ppm. Then, the acetic acid fermented broth B was stored with stirring for 14 days in a similar manner as test example 2, and an acetic acid fermented broth having the final oxalic acid concentration of 34 ppm was obtained.

The two kinds of acetic acid fermented broths prepared as above were filtrated, and filled into bottles, and the bottles were thermally sterilized, and sealed. No occurrence of white precipitation of oxalate was observed in the two kinds of rice black vinegar after cold storage (5° C.) for 3 months.

Next, as to acetic acid fermented broths A and B described above, storage period required for oxalic acid removal treatment and the oxalic acid concentrations in the final rice black vinegar were compared. The results are shown in table 4.

TABLE 4

| | | Storage | Oxalic acid |
|---|---|---|---|
| | Oxalic acid removal | period | concentration |
| Category | treatment | (day) | (ppm) |
| Acetic acid fermented | Concentrated | 4 | 24 |
| broth A | rice-saccharified | | |
| | solution | | |
| Acetic acid fermented | Acetic acid | 14 | 34 |
| broth B | fermented broth | | |

According to the results, it was confirmed that it was better to perform oxalic acid removal treatment at saccharified solution stage, because when oxalic acid removal treatment was performed at concentrated saccharified solution stage, the stirring storage period required for oxalic acid removal treatment became as short as 4 days, and the oxalic acid concentration at rice black vinegar stage could be decreased to 24 ppm or lower concentration in shorter period as low as 24 ppm as compared with the case in which oxalic acid removal treatment was performed at acetic acid fermented broth stage.

Following analysis was carried out, since it could be expected to determine the value, equal to or less than which the oxalic acid concentration in the saccharified solution should be reduced in order to produce black vinegar having the oxalic acid concentration equal to or less than the predetermined value, by using the correlation formula between the oxalic acid concentration in black vinegar and the oxalic acid concentration in saccharified solution (formula 3) obtained in test example 1.

That is, the approximation formula sought for correlation between a and (b×c), wherein, a is the oxalic acid concentration in black vinegar (ppm), b is the oxalic acid concentration in a saccharified solution (ppm), and c is the using ratio of the saccharified solution to total of the alcohol-containing solution and the seed vinegar, was the following formula 3.

a=1.0312(b×c)+1.3421 (Formula 3)

When the formula 3 is transformed, following formula 4 can be obtained.

b=(a−1.3421)÷1.0312÷c (Formula 4)

When black vinegar having an oxalic acid concentration of, for example, 36 ppm or less is to be manufactured, the value, equal to or less than which oxalic acid concentration in the saccharified solution should be decreased, may be calculated by substituting 36 for a in the above formula 4, and the following formula 1 is obtained.

The oxalic acid concentration in the saccharified solution (ppm)=33.6÷the using ratio of the saccharified solution (parts by volume/100), (Formula 1)

wherein the using ratio of the saccharified solution is the ratio to the total of the alcohol-containing solution and the seed vinegar.

Similarly, by substituting 30 for a in the above formula 4, the value, equal to or less than which oxalic acid concentration in the saccharified solution should be decreased, when black vinegar having an oxalic acid concentration of 30 ppm or less is to be manufactured can be calculated, and as a result the following formula 2 is obtained.

The oxalic acid concentration in the saccharified solution (ppm)=27.8÷the using ratio of the saccharified solution (parts by volume/100), (Formula 2)

wherein the using ratio of the saccharified solution is the ratio to total of the alcohol-containing solution and the seed vinegar.

As described above, it was confirmed that, since almost all of oxalic acid in black vinegar is derived from the saccharified solution, and the oxalic acid concentration in black vinegar and the using ratio of the saccharified solution to the total of the alcohol-containing solution and the seed vinegar are in almost proportional relation, when black vinegar, for example, having an oxalic acid concentration of 36 ppm or less is to be manufactured, the oxalic acid concentration in the saccharified solution is set at the value equal to or less than the value determined by the above formula 1. Similarly, it was confirmed that when black vinegar having an oxalic acid concentration of 30 ppm or less is to be manufactured, the oxalic acid concentration in the saccharified solution is set at the value equal to or less than the value determined by the above formula 2.

### Example 1

### 1. Preparation of a Concentrated Rice-Saccharified Solution

Seven Kg of rice that was ground (polishing ratio: 5%) was suspended in water so as to make a total volume of 20 L. The suspension was added with 20 g of an α-amylase preparation (Kleistase T-5: manufactured by Daiwa Kasei K.K.), and liquefied while maintaining at 90° C. for 90 minutes with stirring. The α-amylase was inactivated by heating the liquid at 120° C. for 20 minutes under pressure, and then the liquid was cooled to 58° C., and added with 40 g of a glucoamylase preparation (Sumizyme: manufactured by Shin Nihon Chemical Co., Ltd.) and 10 g of a protease preparation (Sumizyme LP-50: manufactured by Shin Nihon Chemical Co., Ltd.). Saccharification was continued at 58° C. for 18 hours, and then by filtration with filter press, a rice-saccharified solution was obtained.

The sugar content of the rice-saccharified solution was 24 weight/volume %. Then, the rice-saccharified solution was concentrated under reduced pressure and a concentrated rice-saccharified solution having a sugar concentration of 50 weight/volume % was prepared. Then, the obtained concentrated rice-saccharified solution was stored with stirring for 5 days in a similar manner as test example 2, and the oxalic acid concentration was decreased to 60 ppm.

Note that, in the present example, the measurements of the sugar concentration and the oxalic acid concentration were done in a similar manner as test example 1.

### 2. Preparation of a Rice Alcoholic Fermented Broth

Six Kg of rice that was ground (polishing ratio: 5%), 1 Kg of rice koji that was ground (prepared in a similar manner as test example 1), 20 g of an α-amylase preparation (Kleistase T-5: manufactured by Daiwa Kasei K.K.), 20 g of a glucoamylase preparation (Sumizyme: manufactured by Shin Nihon Chemical Co., Ltd.), and 40 g of a protease preparation (Sumizyme LP-50: manufactured by Shin Nihon Chemical Co., Ltd.) were suspended in water so as to make a total volume of 20 L. The suspension was added with 25 g of yeast (Saccharomyces cerevisiae (manufactured by Oriental Yeast Co., Ltd.)), subjected to alcoholic fermentation at 30° C. for 5 days, filtrated, and a rice alcoholic fermented broth was obtained. The alcohol concentration of the rice alcoholic fermented broth was 15 volume/volume %.

### 3. Preparation of Rice Black Vinegar

Seventy parts by volume of the alcohol-containing solution (alcohol concentration: 2.5%) prepared by mixing 36 parts by volume of the concentrated rice-saccharified solution described above, 14 parts by volume of the rice alcoholic fermented broth and 20 parts by volume of water was mixed with 30 parts by volume of the seed culture (prepared in a similar manner as test example 1). The mixture was subjected to acetic acid fermentation by submerged fermentation method (at 30° C., 500 rpm, 0.2 vvm) until its alcohol concentration became approximately 0.3 volume/volume %, and a fermented broth after completion of acetic acid fermentation was obtained. The fermented broth had the acidity of 4.5%, the alcohol concentration of 0.3 volume/volume %, the sugar concentration of 18 weight/volume %, and the oxalic acid concentration of 24 ppm.

Then, the fermented broth was filtrated, filled into bottles, thermally sterilized, sealed, and rice black vinegar was obtained. In the rice black vinegar, no occurrence of white precipitation of oxalate was observed after cold storage (5° C.) for 3 months. In addition, the rice black vinegar could be drunk deliciously only by diluting with water.

### Example 2

### 1. Preparation of a Concentrated Barley-Saccharified Solution

Seven Kg of unpolished barley that was ground was suspended in water so as to make a total volume of 20 L. The suspension was added with 20 g of an α-amylase preparation (Kleistase T-5: manufactured by Daiwa Kasei K.K.), and liquefied while maintaining at 90° C. for 90 minutes with stirring. The α-amylase was inactivated by heating the liquid at 120° C. for 20 minutes under pressure, and then the liquid was cooled to 58° C., and added with 40 g of a glucoamylase preparation (Sumizyme: manufactured by Shin Nihon Chemical Co., Ltd.) and 10 g of a protease preparation (Sumizyme LP-50: manufactured by Shin Nihon Chemical Co., Ltd.). Saccharification was continued at 58° C. for 18 hours, and then by filtration with filter press, a barley-saccharified solution was obtained. Then, the barley-saccharified solution was concentrated under reduced pressure and a concentrated barley-saccharified solution was obtained.

The concentrated barley-saccharified solution had the sugar concentration of 50 weight/volume % and the oxalic acid concentration of 168 ppm. The concentrated barley-saccharified solution was stored still in a refrigerator (4° C.) for a month to reduce the oxalic acid concentration. The oxalic acid concentration after storage was 55 ppm.

### 2. Preparation of a Barley Alcoholic Fermented Broth

Seven Kg of steamed barley (polishing ratio: 10%), 20 g of an α-amylase preparation (Kleistase T-5: manufactured by Daiwa Kasei K.K.), 20 g of a glucoamylase preparation (Sumizyme: manufactured by Shin Nihon Chemical Co., Ltd.), and 40 g of a protease preparation (Sumizyme LP-50: manufactured by Shin Nihon Chemical Co., Ltd.) were suspended in water so as to make a total volume of 20 L. The suspension was added with 25 g of yeast (Saccharomyces cerevisiae (manufactured by Oriental Yeast Co., Ltd.)), subjected to alcoholic fermentation at 30° C. for 5 days, filtrated, and a barley alcoholic fermented broth was obtained. The alcohol concentration of the barley alcoholic fermented broth was 14.2 volume/volume %.

### 3. Preparation of Barley Black Vinegar

The alcohol-containing solution (the alcohol concentration: 2.5%) was prepared by mixing 45 parts by volume of the concentrated barley-saccharified solution, 18 parts by volume of the barley alcoholic fermented broth and 7 parts by volume of water. Then 30 parts by volume of the seed culture (prepared in a similar manner as test example 1) added with 70 parts by volume of the alcohol-containing solution was subjected to acetic acid fermentation by submerged fermentation method (at 30° C., 500 rpm, 0.2 vvm) until its alcohol concentration became approximately 0.3 volume/volume %, and a fermented broth after the completion of acetic acid fermentation was obtained.

The obtained fermented broth had the acidity of 4.5%, the alcohol concentration of 0.3 volume/volume %, the sugar concentration of 22 weight/volume %, and the oxalic acid concentration of 25 ppm. Then, the fermented broth was filtrated, filled into bottles, thermally sterilized, sealed, and barley vinegar was obtained. In the barley black vinegar, no occurrence of white precipitation of oxalate was observed after cold storage (5° C.) for 3 months. In addition, the barley black vinegar could be drunk deliciously only by diluting with water.

Note that, in the present example, the measurements of the sugar concentration and the oxalic acid concentration were done in a similar manner as test example 1.

### Example 3

Seven Kg of rice that was ground (polishing ratio: 5%) was suspended in water so as to make a total volume of 20 L. The suspension was added with 20 g of an α-amylase preparation (Kleistase T-5: manufactured by Daiwa Kasei K.K.), and liquefied while maintaining at 90° C. for 90 minutes with stirring. The α-amylase was inactivated by heating the liquid at 120° C. for 20 minutes under pressure, and then the liquid was cooled to 58° C., and added with 40 g of a glucoamylase preparation (Sumizyme: manufactured by Shin Nihon Chemical Co., Ltd.) and 10 g of a protease preparation (Sumizyme LP-50: manufactured by Shin Nihon Chemical Co., Ltd.). Saccharification was continued at 58° C. for 18 hours, and then by filtration with filter press, a rice-saccharified solution was obtained. The sugar content of the rice-saccharified solution was 24 weight/volume %.

Also, 6 Kg of rice that was ground (polishing ratio: 5%), 1 Kg of rice koji that was ground (prepared in a similar manner as test example 1), 20 g of an α-amylase preparation (Kleistase T-5: manufactured by Daiwa Kasei K.K.), 20 g of a glucoamylase preparation (Sumizyme: manufactured by Shin Nihon Chemical Co., Ltd.), and 40 g of a protease preparation (Sumizyme LP-50: manufactured by Shin Nihon Chemical Co., Ltd.) were suspended in water so as to make a total volume of 20 L. The suspension was added with 25 g of yeast (Saccharomyces cerevisiae (manufactured by Oriental Yeast Co., Ltd.)), and subjected to alcoholic fermentation at 30° C. for 5 days, filtrated, and a rice alcoholic fermented broth was obtained. The alcohol concentration of the rice alcoholic fermented broth was 14.9 volume/volume %.

To 33 parts by volume of the rice-saccharified solution and 25 parts by volume of the rice alcoholic fermented broth, 25 parts by volume of the seed vinegar (an unpolished rice acetic acid fermented broth having acetic acid concentration of 7.5% and the sugar content of 0%) and 17 parts by volume of water were added. The obtained solution was inoculated by pellicle of acetic acid bacterial (collected from static fermenting broth of vinegar) at approximately 30% of surface area of the solution, was subjected to static fermentation at 30° C. for 2 weeks, and after the completion of the fermentation, the acetic acid bacteria were filtrated, whereby obtaining a fermented broth having the acidity of 5% and the alcohol concentration of 0.4 volume/volume %.

The fermented broth had the sugar content of 8 weight/volume % and the oxalic acid concentration of 42 ppm. The fermented broth was mixed with 0.3 weight/volume % of anion-exchange resin (Diaion WA21J, manufactured by Mitsubishi Chemical Corporation), and after 3 hours of stirring, the anion-exchange resin was filtrated and the fermented broth was filled into bottles, thermally sterilized, and sealed, whereby manufacturing rice black vinegar.

The rice black vinegar had the oxalic acid concentration of 23 ppm and was free from oxalate precipitation even after cold storage (5° C.) for 6 months. The rice black vinegar had preferable quality, and was suitable for drinking.

Note that, in the present example, the measurements of the sugar concentration and the oxalic acid concentration were done in a similar manner as test example 1.

1. A manufacturing method of black vinegar containing 8-50 weight/volume % of sugar derived from rice and/or barley, wherein a saccharified solution and an alcoholic fermented broth of rice and/or barley are mixed to perform acetic acid fermentation, and the final concentration of oxalic acid in black vinegar is decreased to 36 ppm or less.

2. The manufacturing method of black vinegar according to claim 1, wherein the final concentration of oxalic acid in black vinegar is decreased to 30 ppm or less.

3. The manufacturing method of black vinegar according to claim 1, wherein the saccharified solution prepared in such a manner that the concentration of oxalic acid is equal to or less than the value given by the following formula 1,
oxalic acid concentration in the saccharified solution (ppm)=33.6÷the using ratio of the saccharified solution (parts by volume/100). (Formula 1)

4. The manufacturing method of black vinegar according to claim 2, wherein the saccharified solution prepared in such a manner that the concentration of oxalic acid is equal to or less than the value given by the following formula 2,
oxalic acid concentration in the saccharified solution (ppm)=27.84÷the using ratio of the saccharified solution (parts by volume/100). (Formula 2)

5. The manufacturing method of black vinegar according to any one of claims 1 to 4, wherein oxalic acid removal treatment is performed by storing the saccharified solution with stirring.

6. The manufacturing method of black vinegar according to any one of claims 1 to 4, wherein oxalic acid removal treatment is performed by storing the fermented broth after completion of acetic acid fermentation with stirring.

7. Black vinegar produced by manufacturing method according to any one of claims 1 to 4.
